(19) United States
(12) Patent Application Publication
(10) Pub. No.: US 2018/0069360 A1
(43) Pub. Date: Mar. 8, 2018

(54) USB-SHAPED CONNECTOR, DATA TRANSMISSION DEVICE AND DATA STORAGE DEVICE

(71) Applicant: APACER TECHNOLOGY INC., New Taipei City (TW)

(72) Inventors: Jiunn-Chang Lee, New Taipei City (TW); Hung-Wen Pan, New Taipei City (TW)

(21) Appl. No.: 15/346,020

(22) Filed: Nov. 8, 2016

(30) Foreign Application Priority Data
Sep. 5, 2016 (TW) 105128603

(51) Int. Cl. H01R 27/00; H01R 24/62

(52) U.S. Cl. CPC H01R 27/00; H01R 2107/00; H01R 24/62

(57) ABSTRACT

A USB-shaped connector, a data transmission device and a data storage device are provided. The connector has the appearance of a USB 3.0 Type-A connector. The pins of the connector can support various transmission protocols such as a SATA transmission protocol, a PCIe transmission protocol or a USB transmission protocol. The data transmission device determines the transmission protocol according to the result of detecting the pin definitions of the corresponding male connector. Consequently, the utilization flexibility of the data transmission device is enhanced.

### FIELD OF THE INVENTION

The present invention relates to a USB-shaped connector, a data transmission device and a data storage device, and more particularly to a USB-shaped connector supporting a SATA interface or a PCIe interface, a data transmission device and a data storage device capable of accurately transmitting data through the connector and the corresponding transmission interface.

### BACKGROUND OF THE INVENTION

A USB port has become one of the widely-used connecting ports of a computer. After a peripheral device with a USB plug (e.g., a mouse, an external hard drive or a power bank) is plugged into an electronic device with a USB receptacle, the electronic device transmits electric power to the peripheral device. Consequently, the peripheral device can produce a desired function.

For example, a SATA interface is one kind of computer bus. Through the SATA interface, data can be transmitted between a motherboard and various storage devices (e.g., hard drives or optical disc drives). According to the SATA specifications, SATA 1.5 Gbit/s, SATA 3 Gbit/s and SATA 6 Gbit/s are different SATA versions. Due to the expansive applications of the USB port, a method of connecting a SATA signal pin the USB port was disclosed. Under this circumstance, the USB port can be used to selectively transmit the USB signal and the SATA signal.

In accordance with the above method, metallic USB signal lines and metallic SATA signal lines are respectively formed on a top side and a bottom side of the USB receptacle. After a USB plug of a mobile device (or a storage device) with USB pins or a USB plug of a mobile device (or a storage device) with SATA pins are plugged into this USB receptacle, the pins are contacted with the metallic signals lines to transmit USB signals or SATA signals. However, since the pins corresponding to the two kinds of metallic signal lines are all installed in the USB port, the fabricating cost is increased.

Moreover, for allowing the USB port of the motherboard to transmit a SATA signal to a storage device, a SATA control firmware in the storage device is executed to result in the data communication between the motherboard and the storage device. Since the storage device with the SATA control firmware and the motherboard with this USB port comply with special standards, the applications are limited. Under this circumstance, the fabricating cost increases. Since the storage device complying with the special standard and the motherboard complying with the special standard have to be cooperatively used with each other, the installation cost and the operating inconvenience increase.

### SUMMARY OF THE INVENTION

For solving the drawbacks of the conventional technologies, the present invention provides a USB-shaped connector, a data transmission device and a data storage device.

In accordance with an aspect of the present invention, there is provided a USB-shaped connector. The USB-shaped connector includes a Type-A male connector and a Type-A female connector. The Type-A male connector includes at least one device data transmission differential signal pin, at least one device data receipt differential signal pin, a device power signal pin and at least one device control signal pin. A control potential mode is set through the at least one device control signal pin. The Type-A female connector includes at least one host data transmission differential signal pin, at least one host data receipt differential signal pin, a host power signal pin and at least one host control signal pin. The at least one host data transmission differential signal pin is electrically connected with the at least one device data receipt differential signal pin. The at least one host data receipt differential signal pin is electrically connected with the at least one device data transmission differential signal pin. The host power signal pin is electrically connected with the device power signal pin to transmit electric power to the device power signal pin. The at least one host control signal pin is electrically connected with the at least one device control signal pin.

In accordance with another aspect of the present invention, there is provided a data transmission device. The data transmission device is connected with a data storage device having a Type-A male connector. The Type-A male connector includes at least one device data transmission differential signal pin, at least one device data receipt differential signal pin, a device power signal pin and at least one device control signal pin. The data transmission module includes a Type-A female connector and a bus switch module. The Type-A female connector includes at least one host data transmission differential signal pin, at least one host data receipt differential signal pin, a host power signal pin and at least one host control signal pin. When the Type-A female connector is connected with the Type-A male connector, the at least one host control signal pin is electrically connected with the at least one device control signal pin. The bus switch module is electrically connected with the at least one host control signal pin, the at least one host data transmission differential signal pin, the at least one host data receipt differential signal pin and plural transmission interface control modules. The bus switch module recognizes a transmission interface for the Type-A male connector according to a result of detecting a control potential mode of the at least one device control signal pin, and selects one of the plural transmission interface control modules corresponding to the transmission interface. Consequently, the data transmission between the selected transmission interface control module and the data storage device is performed through the bus switch module.

In accordance with another aspect of the present invention, there is provided a data storage device. The data storage device is connected with a computer host having a Type-A female connector. The Type-A female connector includes at least one host data transmission differential signal pin, at least one host data receipt differential signal pin, a host power signal pin and at least one host control signal pin. The data storage device includes a Type-A male connector and a device bridge processing module. The Type-A male connector includes at least one device data transmission differential signal pin, at least one device data receipt differential signal pin, a device power signal pin and at least one device control signal pin. The device bridge processing module includes at least one device operation firmware. The device bridge processing module is electrically connected with the at least one device data transmission differential signal pin. The at least one device data receipt differential signal pin. The device power signal pin and the at least one device control signal pin. When the Type-A male connector is connected with the Type-A female connector, the at least one device data transmission differential signal pin is electrically connected with the at least one host data receipt differential signal pin, the at least one device data receipt differential signal pin is electrically connected with the at least one host data transmission differential signal pin, the device power signal pin is electrically connected with the host power signal pin, and the at least one device control signal pin is electrically connected with the at least one host control signal pin. The device bridge processing module recognizes a transmission interface for the Type-A female connector according to a result of detecting the at least one host control signal pin, and executes the device operation firmware corresponding to the transmission interface. Consequently, the data transmission between the device bridge processing module and the computer host is performed.

In accordance with another aspect of the present invention, there is provided a data storage device. The data storage device is connected with an electronic device having a Type-A female connector. The data storage device includes a Type-A male connector and a control unit. The Type-A male connector includes at least one device data transmission differential signal pin, at least one device data receipt differential signal pin and a device power signal pin. The control unit includes at least one device operation firmware. The control unit is electrically connected with the at least one device data transmission differential signal pin, the at least one device data receipt differential signal pin, the device power signal pin and at least one device control signal pin. The control unit receives a firmware switching signal through the at least one device control signal pin, and selects and executes one of the at least one device operation firmware according to the firmware switching signal. Consequently, a transmission interface for the Type-A male connector is changed.

From the above descriptions, the present invention provides a USB-shaped connector, a data transmission device and a data storage device. The technologies of the present invention have the following advantages. Firstly, the USB-shaped connector can support various transmission protocols such as the SATA transmission protocol, the PCIe transmission protocol or the USB transmission protocol. Secondly, the data transmission device selects a corresponding transmission protocol according to a result of detecting the control potential mode of the control signal pin of the Type-A male connector. Consequently, the electronic device with the Type-A female connector and the mobile device with the Type-A male connector can be in communication with each other to transmit data. Thirdly, since an operation firmware corresponding to the transmission interface of the Type-A female connector is executed by the data storage device, the utilization flexibility of the data storage device is enhanced.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a USB-shaped connector according to an embodiment of the present invention;

FIG. 2 is a schematic view illustrating the Type-A male connector of the USB-shaped connector according to the embodiment of the present invention;

FIG. 3 is a schematic view illustrating the Type-A female connector of the USB-shaped connector according to the embodiment of the present invention;

FIG. 4 is a schematic functional block diagram illustrating a data transmission device according to an embodiment of the present invention;

FIG. 5 is a schematic functional block diagram illustrating a data storage device according to a first embodiment of the present invention; and

FIG. 6 is a schematic functional block diagram illustrating a data storage device according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

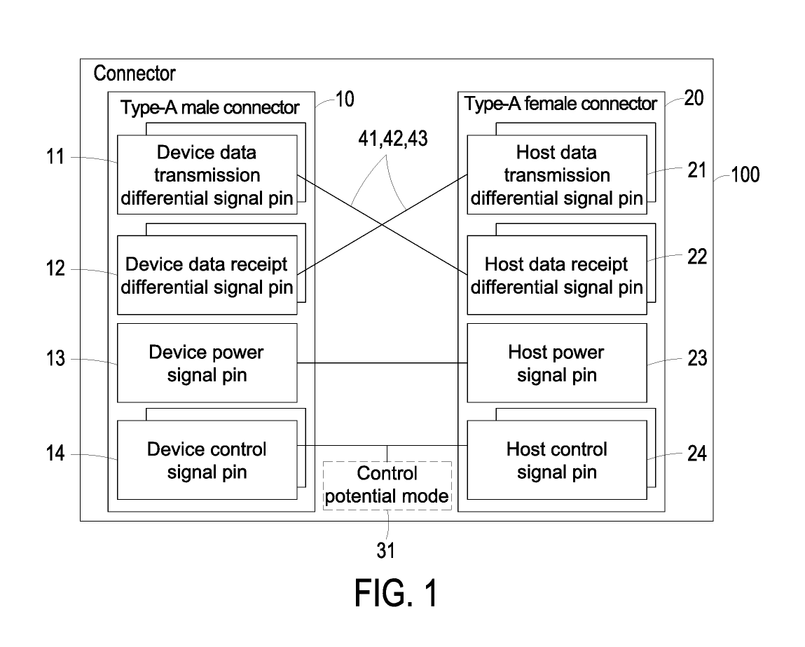

FIG. 1 is a schematic functional block diagram illustrating a USB-shaped connector according to an embodiment of the present invention. The USB-shaped connector 100 comprises a Type-A male connector 10 (such as a plug) and a Type-A female connector 20 (such as a receptacle or socket). The Type-A male connector 10 is installed on a flash drive, an external hard drive or a multimedia device. The Type-A female connector 20 is installed in a workstation or a motherboard of a computer host, or the Type-A female connector 20 is electrically connected with the motherboard.

In this embodiment, the Type-A male connector 10 comprises at least one device data transmission differential signal pin 11, at least one device data receipt differential signal pin 12, a device power signal pin 13 and at least one device control signal pin 14. These pins are installed on a tongue plate of the Type-A male connector 10. The device data transmission differential signal pin 11 is used for transmitting signals, and the device data receipt differential signal pin 12 is used for receiving signals. Moreover, a control potential mode 31 is set through the device control signal pin 14.

The Type-A female connector 20 comprises at least one host data transmission differential signal pin 21, at least one host data receipt differential signal pin 22, a host power signal pin 23 and at least one host control signal pin 24. The positions of these pins of the Type-A female connector 20 are aligned with the positions of the corresponding pins of the Type-A male connector 10.

In an embodiment, the Type-A female connector 20 is included in a computer host, and the Type-A male connector 10 is included in a flash drive. The Type-A male connector 10 is plugged into the Type-A female connector 20. Meanwhile, the host data transmission differential signal pin 21 is electrically connected with the device data receipt differential signal pin 12, and the host data receipt differential signal pin 22 is electrically connected with the device data transmission differential signal pin 11. Moreover, the host power signal pin 23 is electrically connected with the device power signal pin 13 to transmit electric power to the device power signal pin 13. That is, the computer host provides the electric power to the flash drive. Moreover, the host control signal pin 24 is electrically connected with the device control signal pin 14. Consequently, the computer host can detect the control potential mode 31 of the device control signal pin 14.

In an embodiment, the control potential mode 31 includes a SATA mode. In the SATA mode, the device data transmission differential signal pin 11 transmits a SATA signal 41 to the host data receipt differential signal pin 22, and the device data receipt differential signal pin 12 receives the SATA signal 41 from the host data transmission differential signal pin 21. That is, the SATA signal 41 can be transmitted between the computer host and the flash drive through the corresponding pins. Moreover, the host data transmission differential signal pin 21, the host data receipt differential signal pin 22, the device data transmission differential signal pin 11 and the device data receipt differential signal pin 12 are differential signal pins for illustration.

In another embodiment, the control potential mode 31 is a PCIe mode. In the PCIe mode, the device data transmission differential signal pin 11 transmits a PCIe signal 42 to the host data receipt differential signal pin 22, and the device data receipt differential signal pin 12 receives the PCIe signal 42 from the host data transmission differential signal pin 21. That is, the PCIe signal 42 can be transmitted between the computer host and the flash drive through the corresponding pins.

In a further embodiment, the control potential mode 31 is a USB mode. In the USB mode, the device data transmission differential signal pin 11 transmits a USB signal 43 to the host data receipt differential signal pin 22, and the device data receipt differential signal pin 12 receives the USB signal 43 from the host data transmission differential signal pin 21. That is, the USB signal 43 can be transmitted between the computer host and the flash drive through the corresponding pins.

In accordance with the present invention, the default control potential mode 31 is one of the SATA mode, the PCIe mode and the USB mode. Consequently, data transmission between the Type-A female connector 20 and the Type-A male connector 10 is performed according to a default transmission protocol. For meeting different requirements of the user, the user can set the control potential mode 31 to determine the transmission protocol of the flash drive to be one of the SATA mode, the PCIe mode and the USB mode.

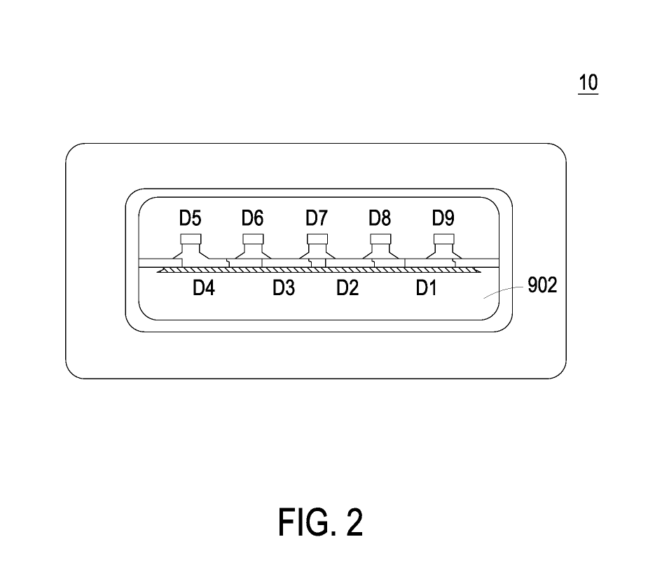

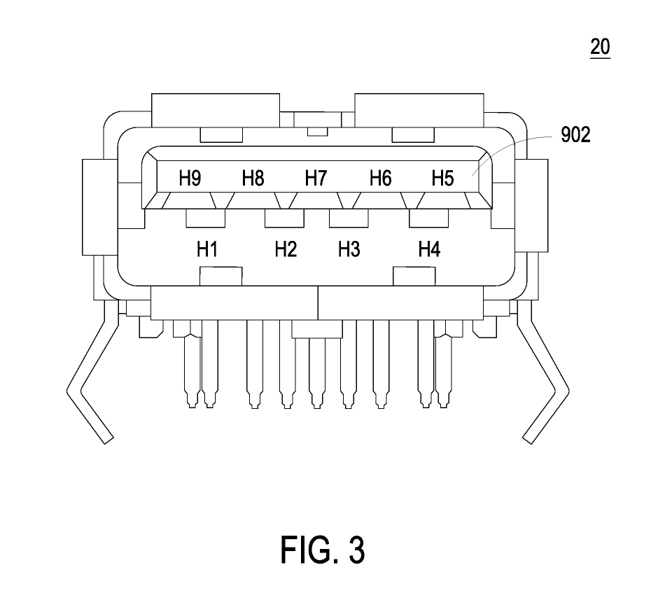

FIG. 2 is a schematic view illustrating the Type-A male connector of the USB-shaped connector according to the embodiment of the present invention. FIG. 3 is a schematic view illustrating the Type-A female connector of the USB-shaped connector according to the embodiment of the present invention. Please refer to FIGS. 1, 2 and 3. For example, the Type-A male connector 10 is included in a mobile device, and the Type-A female connector 20 is included in a computer host. The Type-A male connector 10 and the Type-A female connector 20 are connected with each other. As shown in FIG. 2, the Type-A male connector 10 comprises a tongue plate 902. Moreover, nine pins D1˜D9 are located at a side of the tongue plate 902. The pin D1 is the device power signal pin 13. The pins D5 and D6 are the device data receipt differential signal pins 12. The pins D8 and D9 are the device data transmission differential signal pins 11. The pins D2 and D3 are the device control signal pins 14. Moreover, the pins D4 and D7 are ground pins. The pins D1˜D4 are formed on a first surface of the tongue plate 902. The pins D5˜D9 are formed on a second surface of the tongue plate 902.

In FIG. 3, the Type-A female connector 20 corresponding to the Type-A male connector 10 is shown. The Type-A female connector 20 comprises nine pins corresponding to the nine pins of the Type-A male connector 10. The pin H1 is the host power signal pin 23. The pins H5 and H6 are the host data transmission differential signal pins 21. The pins H8 and H9 are the host data receipt differential signal pin 22. The pins H2 and H3 are the host control signal pins 24. Moreover, the pins H4 and H7 are ground pins.

According to the pin positions, the Type-A male connector 10 shown in FIG. 2 and the Type-A female connector 20 shown in FIG. 3 are USB 3.0 Type-A connectors. In the nine pins of the tongue plate of the conventional USB 3.0 Type-A connector, four pins support the USB 2.0 standard and five pins support the USB 3.0 standard. While in accordance with the technology of the present invention, the pins of the Type-A male connector 10 and the Type-A female connector 20 are used as fully as possibly. Consequently, the Type-A male connector 10 and the Type-A female connector 20 can support the USB, PCIe or SATA transmission interface.

When the Type-A male connector 10 is plugged into the Type-A female connector 20, the pins H1˜H4 are respectively contacted with the pins D1˜D4 and the pins H5˜H9 are respectively contacted with the pins D5˜D9. It is noted that the Type-A male connector 10 and the Type-A female connector 20 are not restricted to the USB 3.0 Type-A connectors. Moreover, the sequence of the pins on the tongue plate 902 may be varied according to the practical requirements.

In this embodiment, the Type-A male connector 10 comprises two device control signal pins 14. The voltage levels of these two device control signal pins 14 include four possible sets, i.e., (Low, Low), (Low, High), (High, Low) and (High, High). Moreover, different sets of the voltage levels indicate different transmission protocols of the control potential modes 31. For example, the voltage level set (Low, High) indicates the transmission protocol of the SATA mode, the voltage level set (High, Low) indicates the transmission protocol of the USB mode, and the voltage level set (High, High) indicates the transmission protocol of the PCIe mode.

In addition to the function of indicating the control potential modes 31, the device control signal pins 14 are also employed to manage specified functions of the mobile device. According to the result of detecting the device control signal pins 14, a specified function of the mobile device is selectively enabled or disabled. For example, the specified function includes a write protection function, a security encryption function or an LED flickering function. Since it does not need to additionally execute the software of the computer host to manage the specified function of the mobile device, the connector of the present invention is more user-friendly. In case that the Type-A male connector 10 and the Type-A female connector 20 supports the PCIe transmission protocol, the device control signal pins 14 are defined as reference clock pins.

It is noted that the number of the device control signal pins 14 may be varied according to the practical requirements. For example, if the mobile device communicates with the computer host through the SATA transmission protocol only and not through the other transmission protocols, the Type-A male connector 10 may comprise a single device control signal pin 14 and the Type-A female connector 20 may comprise a single host control signal pin 24.

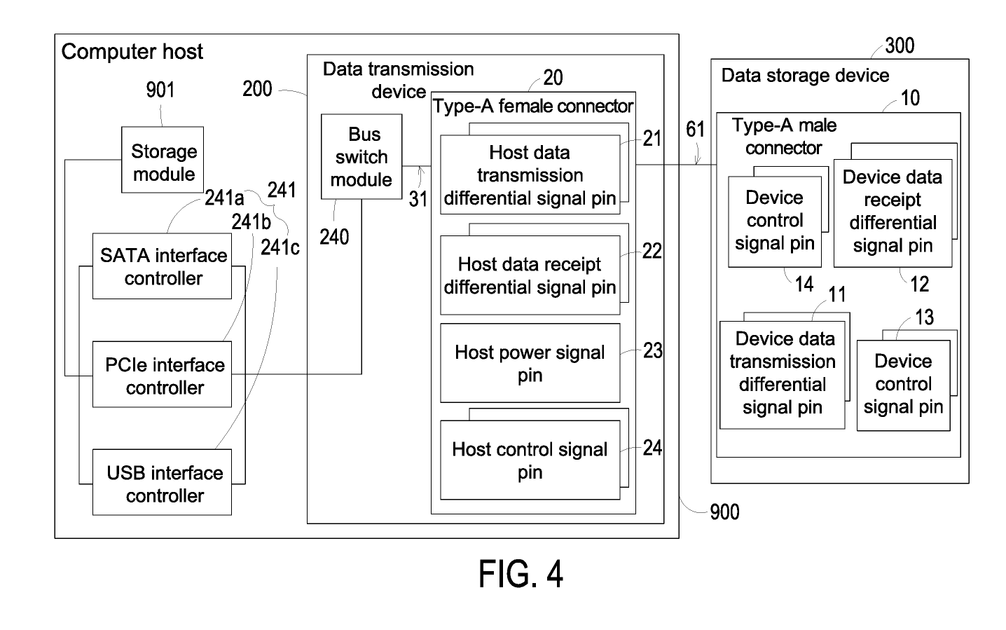

FIG. 4 is a schematic functional block diagram illustrating a data transmission device according to an embodiment of the present invention. Please refer to FIGS. 1 and 4. The data transmission device 200 is applied to connect a data storage device 300 with a Type-A male connector 10. The definitions of the pins of the Type-A male connector 10 have been mentioned as above, and are not redundantly described herein. In this embodiment, the data transmission device 200 is included in a computer host 900, and the data storage device 300 is a flash drive for illustration.

In this embodiment, the data transmission device 200 comprises a Type-A female connector 20 and a bus switch module 240. The Type-A female connector 20 comprises at least one host data transmission differential signal pin 21, at least one host data receipt differential signal pin 22, a host power signal pin 23 and at least one host control signal pin 24. When the Type-A female connector 20 is connected with the Type-A male connector 10, the host control signal pin 24 is electrically connected with the device control signal pin 14 of the Type-A male connector 10.

The bus switch module 240 is a chip module. Moreover, the bus switch module 240 is electrically connected with the host control signal pin 24, the host data transmission differential signal pin 21, the host data receipt differential signal pin 22 and plural transmission interface control modules 241. When the host control signal pin 24 is electrically connected with the device control signal pin 14, the control potential mode 31 of the device control signal pin 14 is detected by the bus switch module 240. According to the control potential mode 31, the bus switch module 240 recognizes a transmission interface 61 for the Type-A male connector 10. Moreover, after one of the plural transmission interface control modules 241 corresponding to the transmission interface 61 is selected, the data transmission between the selected transmission interface control module 241 and the data storage device 300 is performed through the bus switch module 240.

The control potential mode 31 comprises the SATA mode, the PCIe mode and the USB mode. Moreover, the plural transmission interface control modules 241 comprise a SATA interface controller 241a, a PCIe interface controller 241b and a USB interface controller 241c. If the bus switch module 240 detects that the control potential mode 31 corresponding to the transmission interface 61 from the Type-A male connector 10 is the SATA mode, the data from the data storage device 300 is transferred to the SATA interface controller 241a and then the data is transmitted from the SATA interface controller 241a to a storage module 901 of the computer host 900. For example, the storage module 901 is a DRAM. That is, the transmission interface control module 241 for processing the data from the data storage device 300 is determined by the bus switch module 240 according to the detected transmission interface 61. Consequently, the data from the data storage device 300 can be accurately transmitted to the computer host 900.

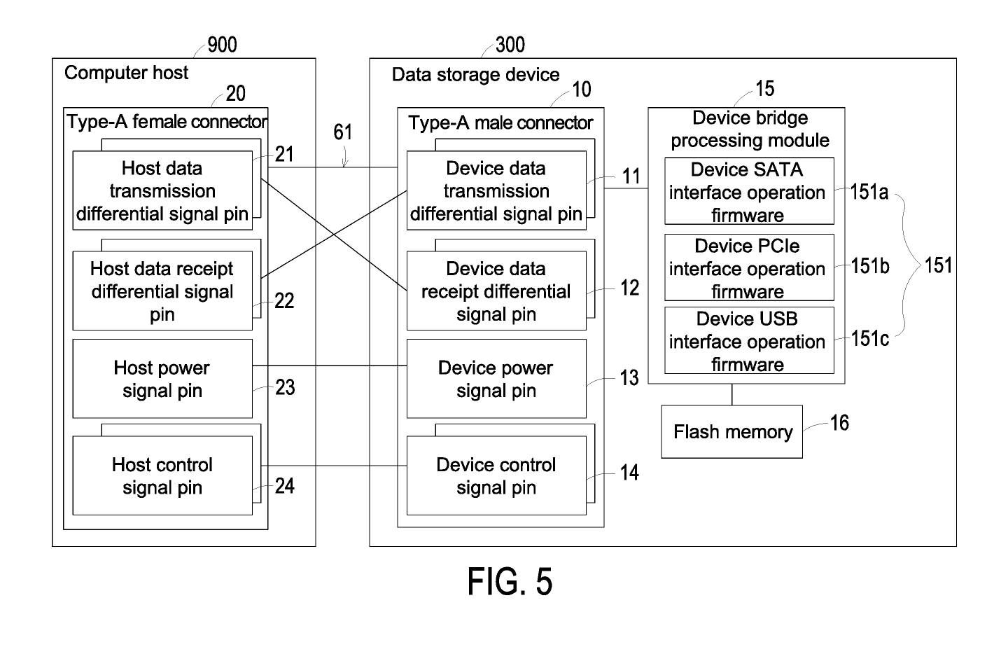

FIG. 5 is a schematic functional block diagram illustrating a data storage device according to a first embodiment of the present invention. The data storage device 300 is applied to connect with a computer host 900 having a Type-A female connector 20. The Type-A female connector 20 comprises at least one host data transmission differential signal pin 21, at least one host data receipt differential signal pin 22, a host power signal pin 23 and at least one host control signal pin 24. The data storage device 300 is an external hard drive or a flash drive. The definitions of the pins of the Type-A female connector 20 have been mentioned as above, and are not redundantly described herein.

Preferably but not restricted, the computer host 900 having the Type-A female connector 20 is a desktop computer. It is noted that any other electronic device with a processor and a storage unit can be used as the computer host 900. For example, the electronic device may be a tablet computer, a workstation or a notebook computer.

In this embodiment, the data storage device 300 comprises a Type-A male connector 10, a device bridge processing module 15 and a flash memory 16. The Type-A male connector 10 comprises at least one device data transmission differential signal pin 11, at least one device data receipt differential signal pin 12, a device power signal pin 13 and at least one device control signal pin 14. The device bridge processing module 15 comprises at least one device operation firmware 151. The flash memory 16 is used for storing a digital data. The definitions of the pins of the Type-A male connector 10 have been mentioned as above, and are not redundantly described herein.

The device bridge processing module 15 is electrically connected with the at least one device data transmission differential signal pin 11, the at least one device data receipt differential signal pin 12, the device power signal pin 13 and the at least one device control signal pin 14. An example of the device bridge processing module 15 is a microcontroller.

Firstly, the Type-A male connector 10 is plugged into the Type-A female connector 20. Meanwhile, the device data transmission differential signal pin 11 is electrically connected with the host data receipt differential signal pin 22, and the device data receipt differential signal pin 12 is electrically connected with the host data transmission differential signal pin 21. Moreover, the device power signal pin 13 is electrically connected with the host power signal pin 23 to receive electric power from the computer host 900. Moreover, the at least one device control signal pin 14 is electrically connected with the host control signal pin 24. Consequently, the device bridge processing module 15 can detect the at least one host control signal pin 24 through the at least one device control signal pin 14 and recognize the transmission interface 61 for the Type-A female connector 20. Then, one of the at least one device operation firmware 151 corresponding to the transmission interface 61 is executed by the device bridge processing module 15. Consequently, the data transmission between the device bridge processing module 15 and the computer host 900 is performed. Meanwhile, the computer host 900 writes data into the flash memory 16 through the device bridge processing module 15, or reads data from the flash memory 16.

In an embodiment, the at least one device operation firmware 151 includes a device SATA interface operation firmware 151a, a device PCIe interface operation firmware 151b and a device USB interface operation firmware 151c. Moreover, the transmission interface 61 includes a SATA interface, a PCIe interface and a USB interface.

In an embodiment, the device control signal pin 14 is a general-purpose input/output (GPIO) pin. Preferably, before the device operation firmware 151 corresponding to the transmission interface 61 is executed by the device bridge processing module 15, the computer host 900 has to perform a cold boot operation.

In an embodiment, the computer host 900 comprises a single transmission interface 61, for example a PCIe interface. When the Type-A male connector 10 is plugged into the Type-A female connector 20 and the data storage device 300 is electrically connected with the computer host 900 for the first time, the device PCIe interface operation firmware 151b of the data storage device 300 is executed. Consequently, the data storage device 300 can transmit and receive the PCIe signal 42 through the corresponding pins of the Type-A male connector 10. The ways of transmitting and receiving signals through the Type-A male connector 10 and the Type-A female connector 20 have been mentioned as above and are not redundantly described herein.

From the above descriptions, the data storage device 300 of the present invention executes the corresponding device operation firmware 151 according to the transmission interface of the computer host 900. Since the transmission interface is not restricted, the utilization flexibility of the data storage device 300 is enhanced.

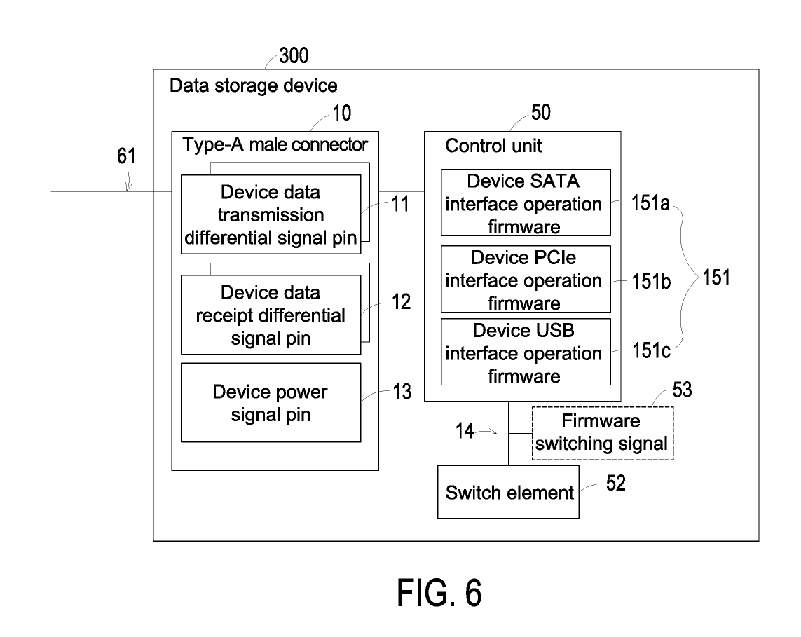

FIG. 6 is a schematic functional block diagram illustrating a data storage device according to a second embodiment of the present invention. The data storage device 300 is applied to connect with an electronic device having a Type-A female connector. In this embodiment, the data storage device 300 comprises a Type-A male connector 10 and a control unit 50. The Type-A male connector 10 has the appearance of a USB Type-A male connector. The control unit 50 comprises a microcontroller. The data storage device 300 is a flash drive for illustration.

In this embodiment, the Type-A male connector 10 comprises at least one device data transmission differential signal pin 11, at least one device data receipt differential signal pin 12 and a device power signal pin 13. Preferably, the Type-A male connector 10 further comprises at least one ground pin (not shown). The ground pin and the device power signal pin 13 are in pairs. Alternatively, the ground pin is arranged between the device data transmission differential signal pin 11 and the device data receipt differential signal pin 12. The ground pin can eliminate the interference of signal transmission.

The control unit 50 is electrically connected with first ends of the at least one device data transmission differential signal pin 11, the at least one device data receipt differential signal pin 12 and the device power signal pin 13. When the Type-A male connector 10 is plugged into the Type-A female connector, the second ends of the at least one device data transmission differential signal pin 11, the at least one device data receipt differential signal pin 12 and the device power signal pin 13 are electrically connected with the corresponding data transmission differential signal pin, the corresponding data receipt differential signal pin and the corresponding power signal pin of the Type-A female connector. Consequently, the data and the electric power can be provided from the electronic device.

Moreover, the control unit 50 is electrically connected with at least one device control signal pin 14. The control unit 50 comprises at least one device operation firmware 151. In an embodiment, the at least one device operation firmware 151 includes a device SATA interface operation firmware 151a, a device PCIe interface operation firmware 151b and a device USB interface operation firmware 151c.

Moreover, the control unit 50 can receive a firmware switching signal 53 through the device control signal pin 14. Moreover, at least one of the device SATA interface operation firmware 151a, the device PCIe interface operation firmware 151b and the device USB interface operation firmware 151c is selected and executed by the control unit 50 according to the firmware switching signal 53. Consequently, a transmission interface 61 corresponding to the Type-A male connector 10 is correspondingly changed.

Moreover, the transmission interface 61 is one of a SATA interface, a PCIe interface and a USB interface. For example, when the device SATA interface operation firmware 151a is executed, the transmission interface 61 is changed to a SATA interface for transmitting a SATA signal. Consequently, the data transmission between the data storage device 300 and the electronic device is performed.

In an embodiment, the at least one device control signal pin 14 is electrically connected with a switch element 52. Moreover, the switch element 52 generates and transmits the firmware switching signal 53 to the control unit 50. An example of the switch element 52 includes but is not limited to a jumper. The number of the at least one device control signal pin 14 is determined according to the number of the at least one device operation firmware 151. In this embodiment, the number of the device operation firmware 151 is three, and the number of the at least one device control signal pin 14 is two. In another embodiment, the data storage device 300 comprises a single device control signal pin 14. In case that the data storage device 300 comprises the single device control signal pin 14, an additional electronic component (e.g., a resistor) is connected with the single device control signal pin 14 to generate different voltage values. The control unit 50 executes the corresponding device operation firmware 151 according to the result of detecting the voltage value.

From the above descriptions, the present invention provides a USB-shaped connector, a data transmission device and a data storage device. The transmission interface of the data storage device is determined according to the user's requirements. Since the transmission interface of the data storage device is not restricted, the utilization flexibility of the data storage device is enhanced. In comparison with the conventional technology, at least one transmission interface is shared by the pins of the data storage device and the connector of the host. In other words, the data storage device of the present invention is cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A USB-shaped connector, comprising:
a Type-A male connector comprising at least one device data transmission differential signal pin, at least one device data receipt differential signal pin, a device power signal pin and at least one device control signal pin, wherein a control potential mode is set through the at least one device control signal pin; and
a Type-A female connector comprising at least one host data transmission differential signal pin, at least one host data receipt differential signal pin, a host power signal pin and at least one host control signal pin,
wherein the at least one host data transmission differential signal pin is electrically connected with the at least one device data receipt differential signal pin, the at least one host data receipt differential signal pin is electrically connected with the at least one device data transmission differential signal pin, the host power signal pin is electrically connected with the device power signal pin to transmit electric power to the device power signal pin, and the at least one host control signal pin is electrically connected with the at least one device control signal pin.

2. The USB-shaped connector according to claim 1, wherein the control potential mode includes a SATA mode, a PCIe mode and a USB mode.

3. The USB-shaped connector according to claim 1, wherein the at least one device data transmission differential signal pin transmits a SATA signal to the at least one host data receipt differential signal pin, and the at least one host data transmission differential signal pin transmits the SATA signal to the at least one device data receipt differential signal pin.

4. The USB-shaped connector according to claim 1, wherein the at least one device data transmission differential signal pin transmits a PCIe signal to the at least one host data receipt differential signal pin, and the at least one host data transmission differential signal pin transmits the PCIe signal to the at least one device data receipt differential signal pin.

5. The USB-shaped connector according to claim 1, wherein the at least one device data transmission differential signal pin transmits a USB signal to the at least one host data receipt differential signal pin, and the at least one host data transmission differential signal pin transmits the USB signal to the at least one device data receipt differential signal pin.

6. The USB-shaped connector according to claim 1, wherein the at least one device control signal pin comprises two device control signal pins, the at least one device data receipt differential signal pin comprises two device data receipt differential signal pins, and the at least one device data transmission differential signal pin comprises two device data transmission differential signal pins.

7. The USB-shaped connector according to claim 1, wherein a specified function is selectively enabled or disabled according to the control potential mode.

8. A data transmission device connected with a data storage device having a Type-A male connector, the Type-A male connector comprising at least one device data transmission differential signal pin, at least one device data receipt differential signal pin, a device power signal pin and at least one device control signal pin, the data transmission device comprising:
a Type-A female connector comprising at least one host data transmission differential signal pin, at least one host data receipt differential signal pin, a host power signal pin and at least one host control signal pin, wherein when the Type-A female connector is connected with the Type-A male connector, the at least one host control signal pin is electrically connected with the at least one device control signal pin; and
a bus switch module electrically connected with the at least one host control signal pin, the at least one host data transmission differential signal pin, the at least one host data receipt differential signal pin and plural transmission interface control modules, wherein the bus switch module recognizes a transmission interface for the Type-A male connector according to a result of detecting a control potential mode of the at least one device control signal pin, and selects one of the plural transmission interface control modules corresponding to the transmission interface, so that a data transmission between the selected transmission interface control module and the data storage device is performed through the bus switch module.

9. The data transmission device according to claim 8, wherein the control potential mode includes a SATA mode, a PCIe mode and a USB mode.

10. The data transmission device according to claim 8, wherein the plural transmission interface control modules comprise a SATA interface controller, a PCIe interface controller and a USB interface controller.

11. A data storage device connected with a computer host having a Type-A female connector, the Type-A female connector comprising at least one host data transmission differential signal pin, at least one host data receipt differential signal pin, a host power signal pin and at least one host control signal pin, the data storage device comprising:
a Type-A male connector comprising at least one device data transmission differential signal pin, at least one device data receipt differential signal pin, a device power signal pin and at least one device control signal pin; and
a device bridge processing module comprising at least one device operation firmware, wherein the device bridge processing module is electrically connected with the at least one device data transmission differential signal pin, the at least one device data receipt differential signal pin, the device power signal pin and the at least one device control signal pin,
wherein when the Type-A male connector is connected with the Type-A female connector, the at least one device data transmission differential signal pin is electrically connected with the at least one host data receipt differential signal pin, the at least one device data receipt differential signal pin is electrically connected with the at least one host data transmission differential signal pin, the device power signal pin is electrically connected with the host power signal pin, and the at least one device control signal pin is electrically connected with the at least one host control signal pin, wherein the device bridge processing module recognizes a transmission interface for the Type-A female connector according to a result of detecting the at least one host control signal pin, and executes the device operation firmware corresponding to the transmission interface, so that a data transmission between the device bridge processing module and the computer host is performed.

12. The data storage device according to claim 11, wherein the at least one device operation firmware includes a device SATA interface operation firmware, a device PCIe interface operation firmware and a device USB interface operation firmware.

13. The data storage device according to claim 11, wherein the transmission interface includes a SATA interface, a PCIe interface and a USB interface.

14. The data storage device according to claim 11, wherein the at least one device control signal pin is a general-purpose input/output (GPIO) pin.

15. The data storage device according to claim 11, wherein before the device operation firmware corresponding to the transmission interface is executed by the device bridge processing module, the computer host performs a cold boot operation.

16. A data storage device connected with an electronic device having a Type-A female connector, the data storage device comprising:
a Type-A male connector comprising at least one device data transmission differential signal pin, at least one device data receipt differential signal pin and a device power signal pin; and
a control unit comprising at least one device operation firmware, wherein the control unit is electrically connected with the at least one device data transmission differential signal pin, the at least one device data receipt differential signal pin, the device power signal pin and at least one device control signal pin,
wherein the control unit receives a firmware switching signal through the at least one device control signal pin, and selects and executes one of the at least one device operation firmware according to the firmware switching signal, so that a transmission interface for the Type-A male connector is changed.

17. The data storage device according to claim 16, wherein the at least one device operation firmware includes a device SATA interface operation firmware, a device PCIe interface operation firmware and a device USB interface operation firmware.

18. The data storage device according to claim 16, wherein the at least one device control signal pin is electrically connected with a switch element, wherein the switch element generates and transmits the firmware switching signal to the control unit.

19. The data storage device according to claim 16, wherein the transmission interface includes a SATA interface, a PCIe interface and a USB interface.
